(19) United States
(12) Patent Application Publication
(10) Pub. No.: US 2010/0095586 A1
(43) Pub. Date: Apr. 22, 2010

(54) PLANT PROPAGATION AND DISPLAY PANEL AND ASSEMBLY

(75) Inventor: Chad Sichello, Delta (CA)

Correspondence Address: FASKEN MARTINEAU DUMOULIN LLP, 2900 - 550 Burrard Street, VANCOUVER, BC, V6C 0A3, CA

(73) Assignee: ECO INNOVATIONS INC., Delta (CA)

(21) Appl. No.: 12/562,087

(22) Filed: Sep. 17, 2009

Related U.S. Application Data
(60) Provisional application No. 61/098,094, filed on Sep. 18, 2008.

(51) Int. Cl. A01G 9/02; A01G 25/00

(52) U.S. Cl. 47/65.9; 47/65.5; 47/79

(57) ABSTRACT

A plant propagation and display panel includes a plant growth substrate housing, a back plate coupled to the plant growth substrate housing, the back plate and the plant growth substrate housing providing an opening for receiving a plant growth substrate and a plant tray coupled to the plant growth substrate housing, the plant tray including a container for receiving a plant plug, the container being at least partly received in the opening.

### RELATED APPLICATION

This application claims benefit under 35 U.S.C. 119(e) of U.S. Provisional Patent Application Ser. No. 61/098,094, filed Sep. 18, 2008, entitled “Plant Propagation and Display Panel and Assembly”, which is incorporated herein by reference in its entirety.

### TECHNICAL FIELD

The present invention relates to green walls and roofs, in particular, a plant propagation and display panel and assembly.

### BACKGROUND

In recent years the push for both industry and individuals to be more environmentally aware has led to many green initiatives including green roofs and green walls. Currently in cities such as Chicago, over 2.5 million square feet of the downtown core roof space are covered with hardy green roof plants. Green walls and roofs provide savings on insulation and place less load bearing strain on a building. In addition, plants being carbon producers, the use of green walls and roofs are thought to decrease greenhouse gas emissions. Further still, these green walls and roofs act to offset the newly identified ‘urban heat island effect’ where the heat-absorbing surfaces in a city raise its temperature to as much as 8 degrees higher than that of the surrounding countryside.

However, green walls currently known in the art have their own unique set of challenges associated with them, the first being gravity. In conventional methods of greening buildings, it is well known to cover wall surfaces with ivy or to plant trees into the soil deposited on wall surfaces. One of the early green walls disclosed in U.S. Pat. No. 5,257,476 requires preparation of a plurality of bags loaded with soil, piling the bags against a wall surface of a building and inserting trees' roots between the piled bags so as to plant trees, erecting a lattice fence outside the stacked bags, and promoting the plants growth and clinging to the lattice.

In more recent years, seeding and planting panels have been used for greening surfaces of permanent constructions such as buildings, retaining walls, and the like. These seeding and planting panels generally include a panel frame, and a seeding and planting mat or block contained within the frame. In general, these types of panel frames are fixedly secured to surfaces of existing constructions such as building wall surfaces, roofs or retaining walls, and are integrally incorporated into the constructions so as to be permanent structural elements thereof. It is very cumbersome to exchange these panels as they are not easily disengaged from their supports and removed. In addition, as the backside faces of the panels are concealed, general maintenance work is very difficult.

### SUMMARY

In one aspect of the present invention, there is provided a plant propagation and display panel including:

a plant growth substrate housing;

a back plate coupled to the plant growth substrate housing, the back plate and the plant growth substrate housing providing an opening for receiving a plant growth substrate; and

a plant tray coupled to the plant growth substrate housing, the plant tray including a container for receiving a plant plug, the container being at least partly received in the opening.

In another aspect of the present invention, there is provided a plant propagation and display assembly including:

a plurality of plant propagation and display panels, each panel having flat corner surfaces; and

a support structure configured for demountably receiving the plurality of plant propagation and display panels.

### DRAWINGS

The following figures set forth embodiments of the invention in which like reference numerals denote like parts. Embodiments of the invention are illustrated by way of example and not by way of limitation in the accompanying figures.

FIG. 1 is an isometric view of a plant propagation and display panel according to an embodiment;

FIG. 1a is an isometric view of the plant propagation and display panel of FIG. 1 including plant plugs and an irrigation line;

FIG. 2 is an exploded isometric view of a plant propagation and display panel according to another embodiment;

FIG. 3 is an isometric view of a back plate of the plant propagation and display panel shown in FIG. 1;

FIG. 4 is an isometric view of a soil housing of the plant propagation and display panel shown in FIG. 1;

FIG. 4a is an enlarged view of a portion of FIG. 4;

FIG. 5 is an isometric view of a plant tray of the plant propagation and display panel shown in FIG. 1;

FIG. 6 is an isometric view of alternate embodiments of containers of the plant tray shown in FIG. 4;

FIG. 7 is a plan view of alternate embodiments of the plant tray shown in FIG. 5;

FIG. 8 is an isometric view of a plug cover of the plant propagation and display panel shown in FIG. 1;

FIG. 9 is an isometric sectional view of the plant propagation and display panel shown in FIG. 1;

FIG. 10A is view of one embodiment of a plant propagation and display assembly mounted to a supporting structure;

FIG. 10B is side view of one embodiment of a plant propagation and display assembly mounted to a supporting structure;

FIG. 11 is a cross-sectional side view on A-A of FIG. 10 of the plant propagation and display assembly;

FIG. 12 is an isometric view of a plant propagation and display assembly according to an embodiment;

FIG. 13 is a front view of a portion of the plant propagation and display assembly shown in FIG. 10;

FIG. 14 is a side view of a portion of the plant propagation and display assembly shown in FIG. 12;

FIG. 15 is an alternate embodiment of multiple nested soil housing units; and

FIG. 16 is an alternate embodiment of multiple nested plant trays.

### DETAILED DESCRIPTION OF EMBODIMENTS OF THE INVENTION

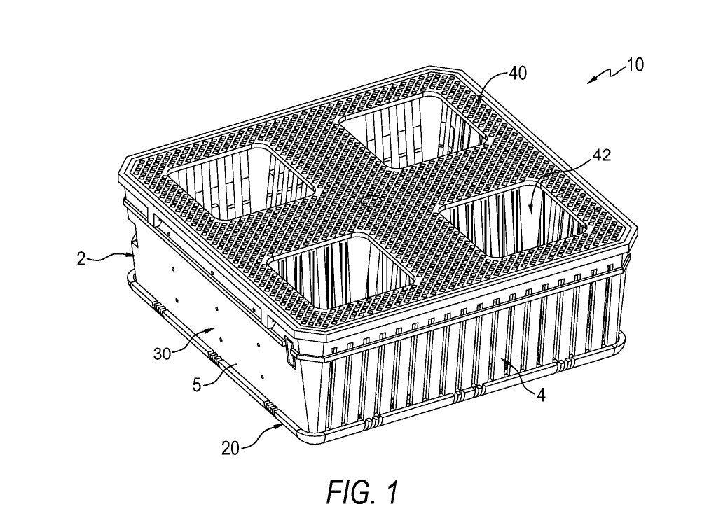

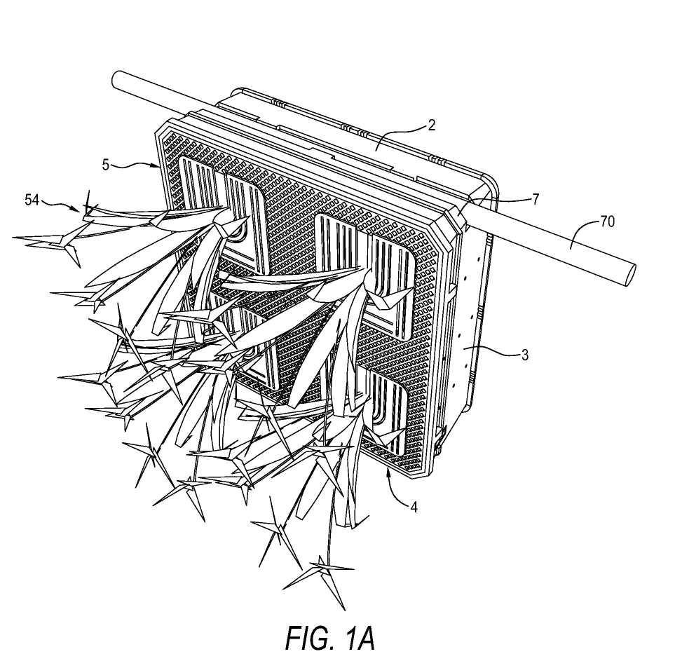

Referring to FIG. 1, an embodiment of a plant propagation and display panel 10 is generally shown. The plant propagation and display panel 10 includes: a plant growth substrate housing 30, a back plate 20 coupled to the plant growth substrate housing, the back plate 20 and the plant growth substrate housing 30 providing an opening for receiving a plant growth substrate. A plant tray 40 is coupled to the plant growth substrate housing 30 and includes a container 42 for receiving a plant plug 54, the container 42 being at least partly received in the opening.

Referring also to FIG. 1a, the plant growth substrate housing 30 includes four side walls: a top side 2, a bottom side 4, a first vertical side 3 and a second vertical side 5; and flat corner surfaces 7. The panel 10 is free-standing and mountable onto a support structure (not shown). It will be appreciated by a person skilled in the art that the sides 2, 4, 3 and 5 have been named for ease of description and do not limit the orientation of the panel 10. The panel 10 may be coupled to a support structure having any orientation including: generally vertical, generally horizontal or another orientation between vertical and horizontal. In one embodiment, the panel 10 is configured for removable engagement with an adjacent panel 10.

As shown, each flat corner surface 7 is provided at a 45-degree angle to the sides 2, 3, 4, and 5 adjacent to each flat corner surface 7, however, it will be appreciated by a person skilled in the art that each flat corner surfaces 7 may be provided at any angle relative to its adjacent sides.

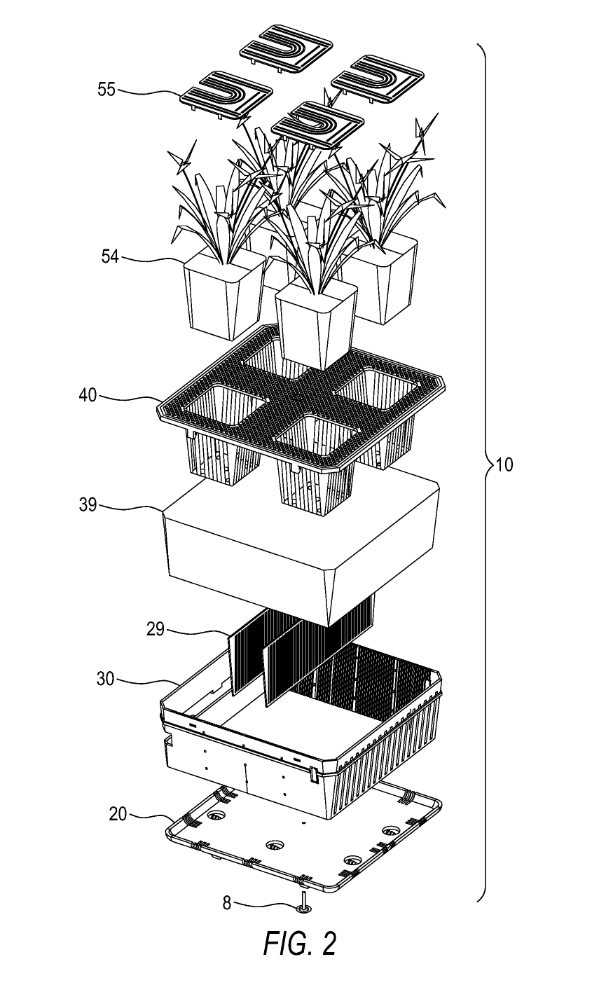

Referring to FIG. 2, another embodiment of a plant propagation and display panel 10 is generally shown. This embodiment is similar to the embodiment of FIG. 1, however, includes screws 8 for fastening the back plate 20 to the plant tray 40, ribs 29 for providing additional structural support to the panel and plug covers 55 for providing protection to the plugs from environmental elements.

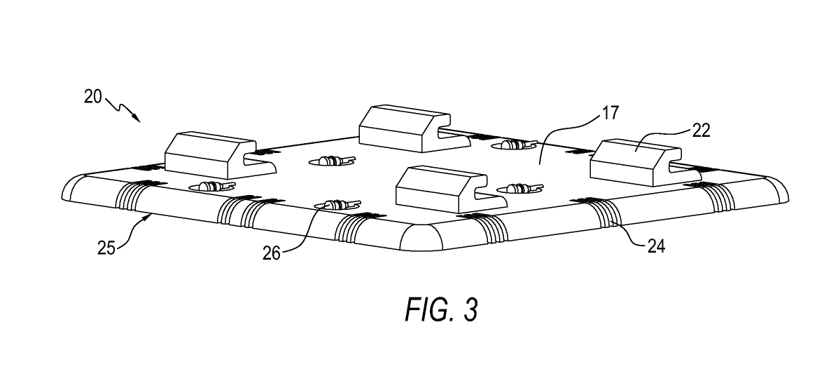

FIG. 3 illustrates an isometric view of an embodiment of back plate 20 which includes a mounting device 22 for coupling the panel 10 to a supporting structure and back plate openings 24 provided to aerate plant growth substrate 39 and to allow drainage. These back plate openings 24 are particularly useful when the panel 10 is lying flat for drainage of excess moisture in the rooting substrates while placed on a horizontal surface, for example during propagation.

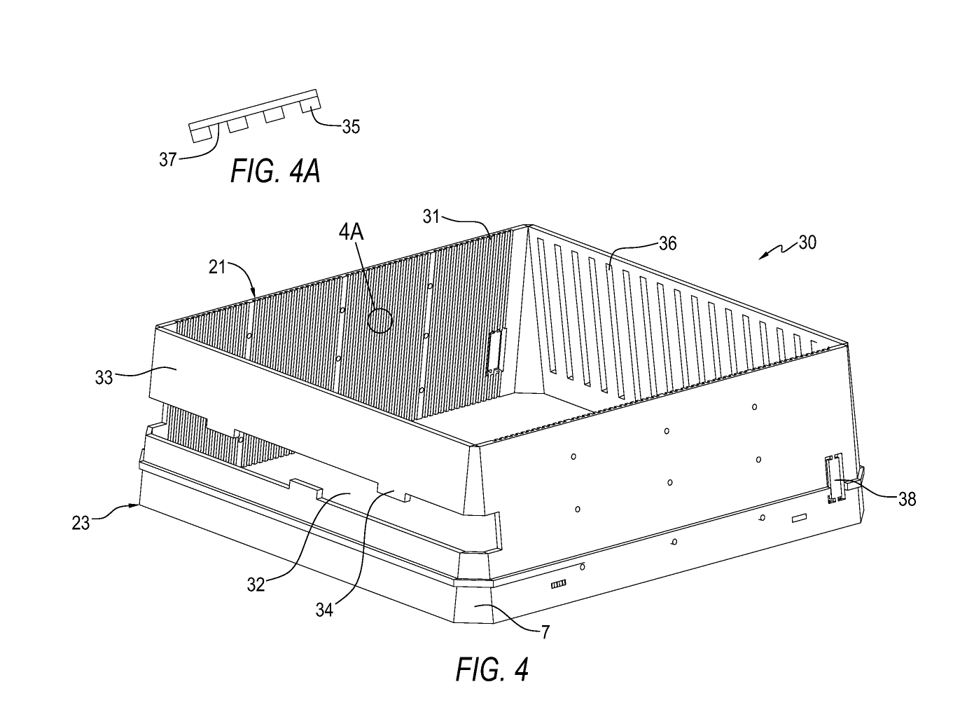

The plant growth substrate housing 30 shown in FIG. 4 is provided with: (a) an irrigation channel opening 32 for receiving an irrigation line 70, and (b) plant growth substrate housing openings 36. The irrigation line 70 is held in place by an irrigation fastening device 34, however, may alternatively be held in place by a latch or a clip, for example. The plant growth substrate housing openings 36 are configured to aerate plant growth substrate 39 and to allow drainage of any excess moisture.

Referring to FIG. 4a, in one embodiment he plant growth substrate housing 30 includes a series of ridges 35 and channels 37 located on the inner surface 31 for removably engaging the rib support 29.

In one embodiment, the plant growth substrate housing 30 is removably coupled to the back plate 20 by a housing fastener (not shown). In another embodiment, the plant growth substrate housing 30 is removably coupled to the back plate 20 by a first housing lip (not shown) protruding from the first edge 21 of the plant growth substrate housing 30 for engagement with the plate lip 25 of the back plate 20. The first housing lip may optionally extend around the entire length of the first edge 21 of the plant growth substrate housing 30.

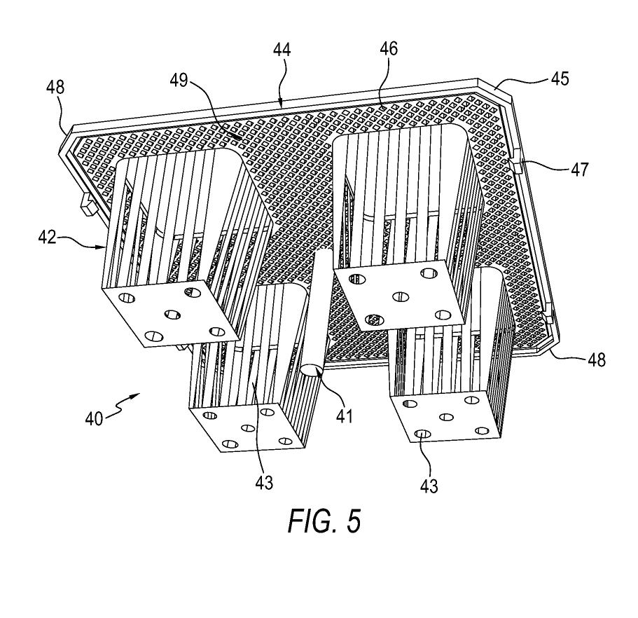

Referring to FIG. 5, the plant tray 40 includes a face plate 44 and containers 42, which are sized to receive plant plugs 54, protruding from the lower surface 49 of the plant tray 40. The face plate 44 includes apertures 46 to provide aeration throughout the plant growth substrate 39 in panel 10 and provide drainage of any excess moisture. The containers 42 have container openings 43 to enable the plugs 54 to communicate with the plant growth substrate 39 and to provide drainage for the plugs 54. In one embodiment, the plant tray 40 is provided with flat tray corner surfaces 48 that are angled to generally match the flat corner surfaces 7 of the plant growth substrate housing 30.

In an alternate embodiment, the plant tray 40 includes a screw housing 41 for receiving a screw (not shown) where the screw housing 41 protrudes from the lower surface 49 of the face plate 44 of the plant tray 40. The screw is inserted through the face plate 44 of the plant tray 40 into the screw housing 41 to engage an opening provided through the inner surface 27 of the back plate 20. The opening includes a securing device 26 to secure the plant tray 40 to the back plate 20. As shown in FIG. 3, multiple securing devices 26 may be provided. In one embodiment, the screw housing is eliminated and a screw extends through the plant growth substrate 39. Providing a screw that extends through the panel 10 sandwiches the plant growth substrate between the face plate 44 of the plant tray 40 and the back plate 20 and provides additional structural support to the panel 10.

In one embodiment, the plant tray 40 is removably coupled to the plant growth substrate housing 30 by tray fasteners 47. In another embodiment, the plant tray 40 is removably coupled to the plant growth substrate housing 30 by a tray lip 45, which protrudes from the lower surface 49 of the face plate 44 of the plant tray 40, for engagement with a second housing lip (not shown) protruding from the second edge 23 of the plant growth substrate housing 30.

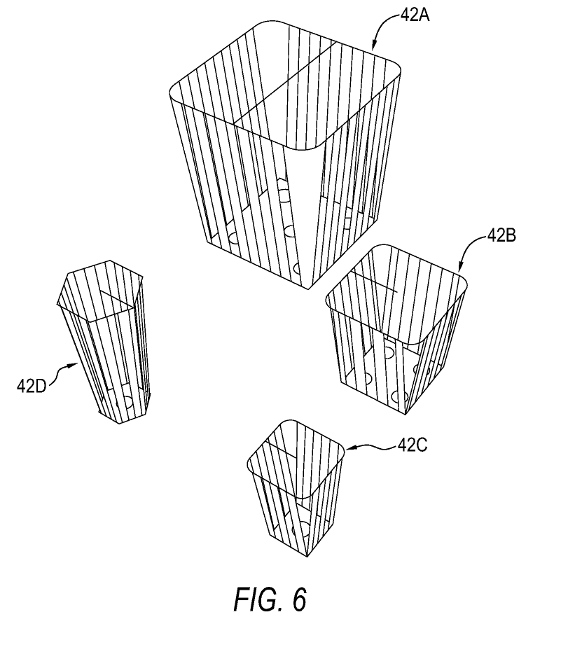

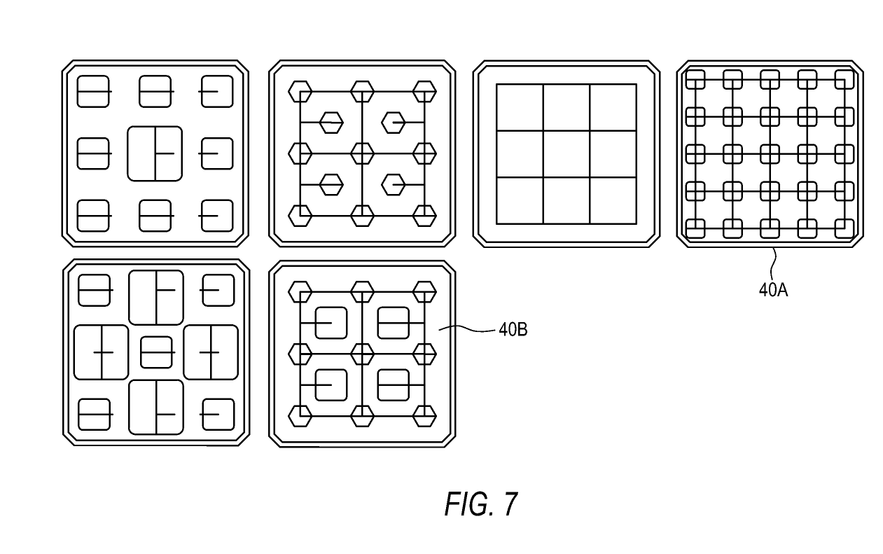

FIG. 6 illustrates alternative embodiments of containers 42 of the plant tray 40. Container 42A is designed to receive a 4-inch plug; container 42B is designed to receive a 2¼-inch plug; container 42C is designed to receive a 128-cell square plug; container 42D is designed to receive a Star 1¼-inch 72 cell plug. FIG. 7 illustrates alternative embodiments of the plant tray 40. For example, plant tray 40A includes 25 containers 42C designed to receive 128-cell square plugs. Plant tray 40B includes 9 containers 42D designed to receive a Star 1¼-inch 72 cell plugs, and 4 containers 42B designed to receive a 2¼-inch plug. It will be appreciated by a person skilled in the art that the configuration of plant trays 40 may be modified to receive different shapes, sizes, and species of plant plugs 54.

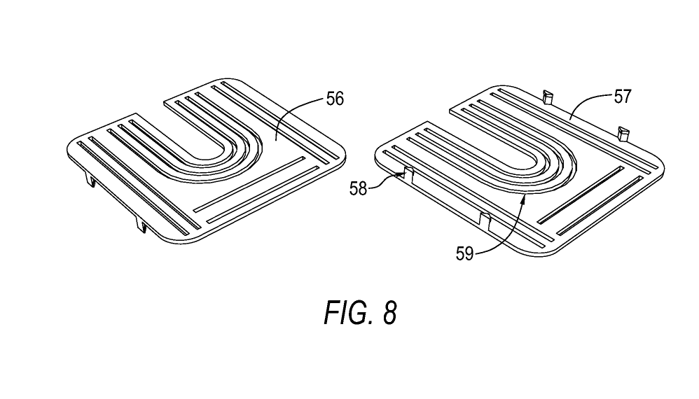

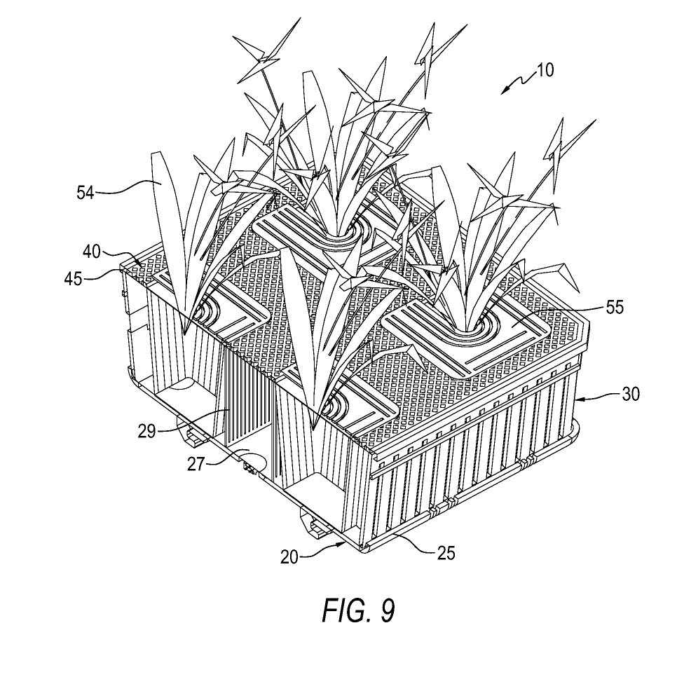

FIG. 8 illustrates an embodiment of the plug cover 55. The plug cover 55 is provided with cover openings 59 to aerate the root zone of a plug 54 and allow drainage of any excess moisture. The plug cover 55 may be removably coupled to the face plate 44 of plant tray 40. In one embodiment, a cover fastener 58 protrudes from the lower surface 57 of the plug cover 55, and is configured for engagement with an aperture 46 of the face plate 44 of the plant tray 40 such that the plug 54 is at least partially covered for protection from environmental elements exemplified by wind and rain.

During assembly of the plant propagation and display panel 10, plant growth substrate 39 is added into the plant growth substrate housing 30 such that the containers 42 of the plant tray 40 are in communication with the plant growth substrate 39. In a further embodiment, the plant growth substrate 39 includes nutrients and other suitable amendments for sustaining the growth and development of the plant material selected for planting in the plugs 54.

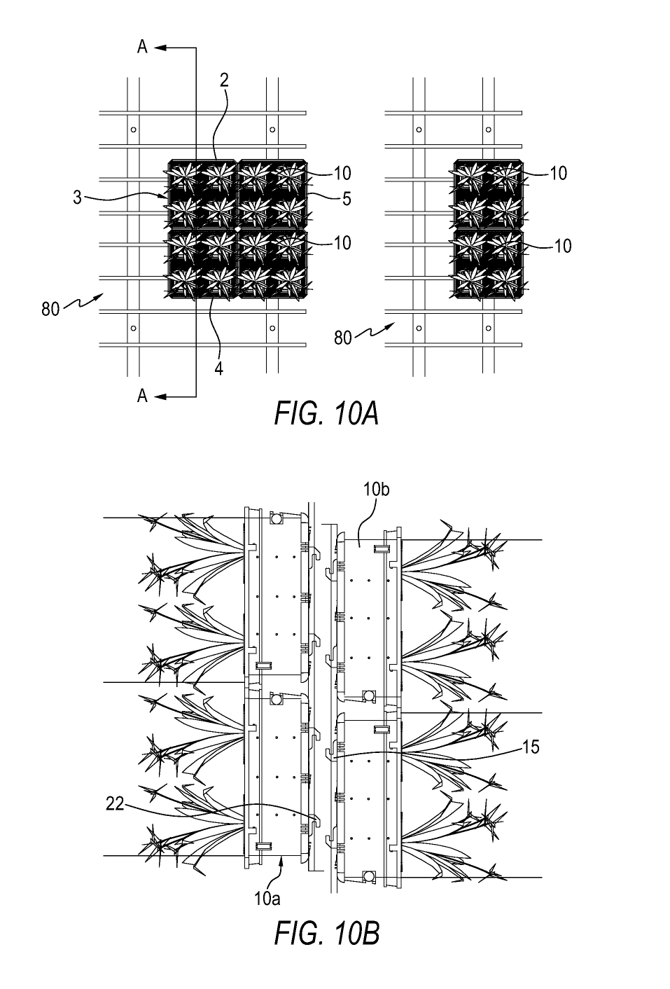

FIG. 10a illustrates one embodiment of a plant propagation and display assembly 1 including multiple panels 10 mounted side-by-side in adjacent rows on a supporting structure 80. In each of the rows, the first side 3 of a panel 10 abuts the second side 5 of an adjacent panel 10 in the same row. The bottom side 4 of a panel 10 abuts the top side 2 of an adjacent panel 10 in the same column. The number of panels 10 mounted on supporting structure 80 is variable depending on the size and shape of the surface on which the supporting structure 80 is secured thereto.

FIG. 10B illustrates an alternative embodiment of a plant propagation and display assembly 1 including a plurality of panels 10 vertically disposed for disengagable mounting to one another. The panels 10 are mounted to one another in the arrangement shown with plate fastening device 15 of panel 10b is configured to removably engage the mounting device 22 of panel 10a. Panel 10b acts as the supporting structure for panel 10a and panel 10a acts as the supporting structure for panel 10b.

In a further alternative embodiment, a free-standing plant propagation and display assembly 1 includes multiple panels 10 displayed side-by-side in adjacent rows. Each of panels 10 are configured for removable engagement with an adjacent panel 10. In each of the rows, the first side 3 of a panel 10 removably engages the second side 5 of an adjacent panel 10 in the same row. The bottom side 4 of a panel 10 removably engages the top side 2 of an adjacent panel 10 in the same column. The number of panels 10 in a free-standing display panel assembly 1 is variable depending on the size and shape of the panels 10 as well as the load-bearing capabilities and stability of the panels 10. A free-standing display panel assembly 1 is particularly useful for display at tradeshows and the like.

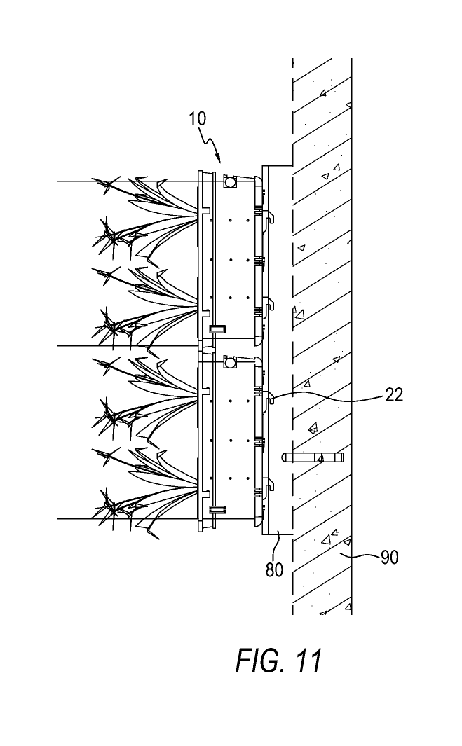

FIG. 11 illustrates a cross-sectional view taken along the plane A-A of FIG. 10A. Panel 10 is disengagably mounted on supporting structure 80 by mounting devices 22. The supporting structure 80 is fixedly attached to a vertical surface 90 of a construction, for example a wall, by any means known in the art exemplified by concrete anchor bolts, tap screws, and spring loaded anchor bolts.

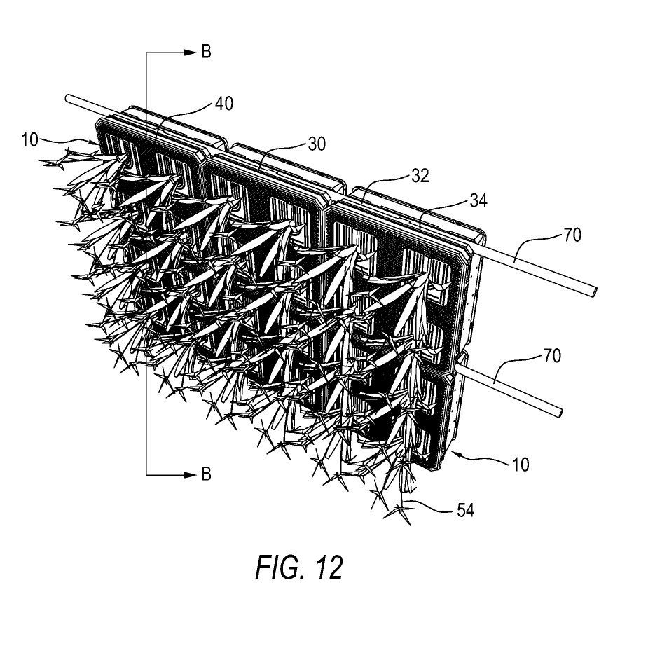

FIG. 12 illustrates an alternate embodiment of the assembly 1 including multiple panels 10 vertically disposed for disengagable mounting on a vertical surface 90. Irrigation line 70 is received within irrigation channel opening 32 of the plant growth substrate housing 30. A single irrigation line 70 runs through multiple panels 10 in a row. Each row has its own irrigation line 70. In one embodiment, the irrigation line 70 is perforated or alternatively, porous as exemplified by a soaker hose for supplying water or the like into the panel 10. In a further embodiment, the irrigation line 70 further includes nozzles (not shown) for feeding water or the like into the panel 10. The nozzles may be non-pressure compensating drip emitters, pressure compensating drip emitters, or any other nozzles known to persons skilled in the art. The irrigation line 70 is connected to an irrigation system, wherein the irrigation system controllably and manipulably provides water, nutrient-enriched water and the like to the panel 10, more specifically to plugs 54 planted in the plant tray 40 and plant growth substrate 39.

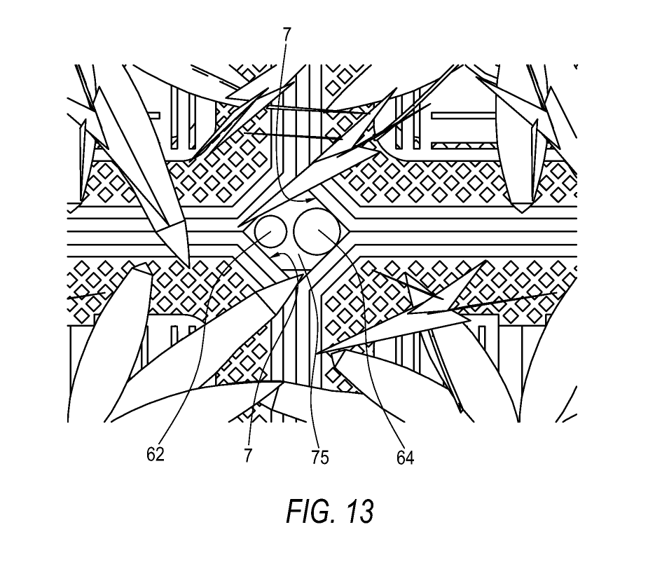

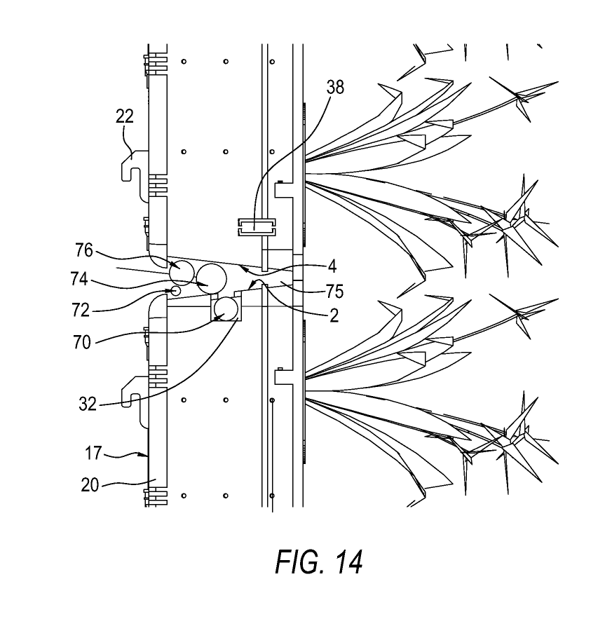

FIG. 13 illustrates the formation of panel orifice 75 when four panels 10 are in abutment with one another, side 3 abuts side 5 of the panels 10 and top side 2 abuts bottom side 4 of the panels 10. The flat corner surface 7 of each abutting panel 10 form an orifice 75 between the panels 10. The flat corner surface 7 of panels 10 enable utility lines to run continuously behind a row of panels 10 of an assembly 1. These utilities may include a heating line 74, electrical wire 72 and a misting water supply line 76 (shown on FIG. 14). The orifice 75 may be configured to facilitate installation of additional design elements exemplified by misters 62 and LED lighting 64. In a further embodiment, the utilities are operatively connected to a utility control system. The utility control system may be wirelessly connected to an external data logger to enable transmission and storage of such that information related to utilities for further analysis and compilation.

FIG. 14 illustrates a partial cross-sectional side view of the plant propagation and display assembly 1 taken along the line B-B of FIG. 12. The bottom side 4 of a panel in abutment with the top side 2 of a second panel. The orifice 75 formed between the panels 10 may optionally house utilities as disclosed above. The orifice 75 may be configured to enable easy access to outer surface 17 of back plate 20 of panel 10, and/or to facilitate installation of additional design elements (not shown) exemplified by misters 62 and LED lighting 64, and may optionally be configured to cooperate with fasteners provided to releasably secure the design elements. In another embodiment the additional design elements may be fixedly secured to panel 10 or support structure 80 (not shown).

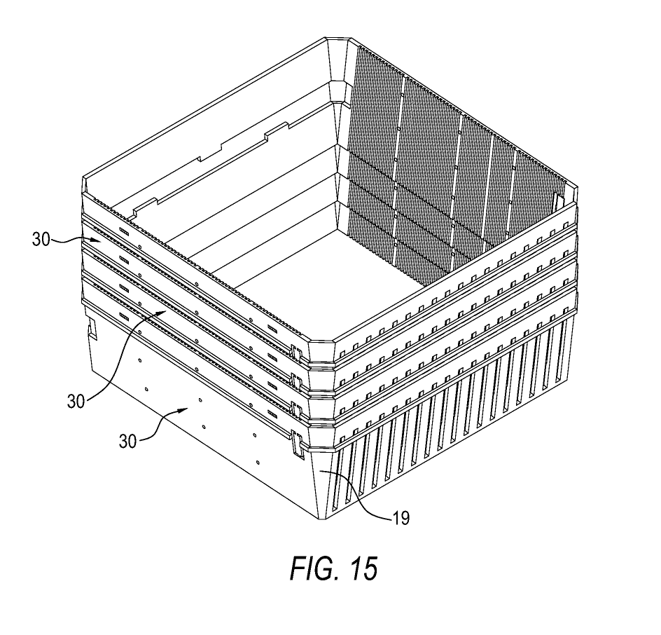

In one embodiment illustrated in FIG. 15, the beveled flat housing corner surface 7 of the plant growth substrate housing 30 and shape of the plant growth substrate housing 30 enable multiple plant growth substrate housing 30 units to be nested into each other. The nesting of the plant growth substrate housing 30 units facilitates ease of shipping and decreased space requirements in shipping containers.

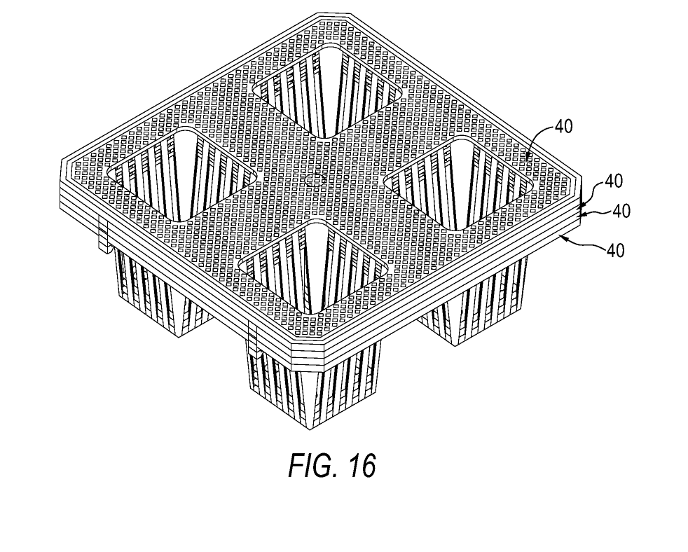

FIG. 16 illustrates an alternate embodiment of multiple plant trays 40 nested together into a stack. The ability to nest multiple plant trays 40 facilitates ease of shipping and decreased space requirements in shipping containers.

Components of the panel 10 are constructed from suitable materials such as extruded plastics, aluminium, stainless steel, or other materials known in the art. Extruded plastics may further include one or more of additional additives for example, anti-microbials, antioxidants, antistatic agents, blowing agents, fragrances, biodegradable plasticizers, biostabilizers, external lubricants, fillers, extenders, flame retardants, heat stabilizers, impact modifiers, internal lubricants, light stabilizers, pigments, process aids, reinforcers, rubberizers, and any other additives known in the art. In one embodiment the extruded plastics include a rubberizer to enable the plastic to maintain flexibility at cooler temperatures. The plastics materials may include one or more of polypropylene (PP), polyethylene (PE), polyethylene terephthalate (PET), polystyrene (PS), polyvinylchloride (PVC), polyfluroethylene (PFE), polyurethane (PU), polytetrafluoroethylene (PTFE) and polycarbonate. Examples of suitable rubberizers include UV additives.

The use of structured plant growth substrates 39 in panel 10 enables the selection of a specific plant growth substrate composition which provides for provision of optimal growing conditions for plant material in plugs 54 placed into the panel 10. This plant growth substrate selection enables increased plant health and plant growth rates, increased plant yield, longer term plant growth substrate stability, improved root establishment in the plant growth substrate base, and improved ability to weather environmental factors such as wind and rain. In one alternate embodiment, the plant growth substrate 39 of panel 10 may be adapted to provide optimized growing conditions for selected plant material in the plugs 54 planted in the panel 10. For example, the plant growth substrate 39 may contain growth additives for the provision of optimized growing conditions for the plant plugs 54. These growth additives may include for example, a mixture of organic and inorganic fertilizers, metal chelates, minerals, plant hormones, and nutrients, as well as other additives known in the art.

In one embodiment, at least one sensor is integrated into the panel 10, for example into the plant growth substrate 39, plant growth substrate housing 30, or rib 29 of panel 10. In the embodiment of FIG. 4, sensor 38 for detecting at least one parameter in the plant growth environment, for example a physico-chemical condition in the root substrate of the plugs 54, is coupled to the plant growth substrate housing 30.

In another embodiment, the sensor 38 detects, compiles, and analyzes data related to the at least one parameter in the plant growth environment. The sensor 38 may, for example, include a temperature sensor or a moisture sensor. Where the sensor 38 is a temperature sensor, the sensor 38 may for example be located on one of an inner surface 31 or an outer surface 33 of the plant growth substrate housing 30, on rib 29, and within the plant growth substrate 39.

Sensors 38 may be moisture sensors, temperature sensors, pH sensors, nutrient sensors selected for monitoring the growing environment of the plugs 54. A moisture sensor may be placed such that it is in communication with plant growth substrate 39 and provides information on the moisture levels in the plant growth substrate 39. A temperature sensor may be placed such that it in communication with the plant growth substrate 39 and provides information on the temperature levels in the plant growth substrate 39. Alternatively a temperature sensor may be secured about a panel 10 to detect and communicate external temperatures. In one embodiment, sensors 38 may be linked wirelessly linked to an external data logger to enable transmission and storage of information for further analysis and compilation. In another embodiment, sensors 38 further include a data logger. In a further embodiment, the at least one sensor 38 is communicable with the utility control system such that a low-temperature reading would communicatingly cooperate with a heating pipe running behind a series of panels, to controllably increase the temperature in a series of panels 10 to optimize the growth conditions of the plugs 54 planted in the panels 10.

In one embodiment, the plant propagation and display assembly 1 is configured to facilitate root migration between adjacent panels 10.

In another embodiment, the plant tray 40 of the plant propagation and display panel 10 does not include containers 42 and instead includes apertures, which are provided at the container locations of the previously described embodiments, and a plant growth substrate housing 30 that incorporates the back plate 20 into a single component. In this embodiment, the plant growth substrate 39 is a structural media with plug-receiving openings provided therein. When assembled, plant plugs 54 are received in the plug-receiving openings and the panel is coupled to a support structure. Similar to the other embodiment disclosed herein, the plant propagation and display panel of this embodiment is free standing and may be coupled to a support structure.

The embodiments of the plant propagation and display panel 10 provide favorable growth conditions for individual plant plugs 54 within each panel 10. In addition, the plant propagation and display panel 10 maintains the plant plugs within the plant tray containers 42 in any panel orientation. The plant propagation and display panel generally eliminates the occurrence of sagging plants in which plants partially or completely separate from panels in vertical configurations.

While embodiments of the present invention have been shown and described herein, it will be obvious to those skilled in the art that such embodiments are provided by way of example only. Numerous variations, changes, and substitutions will be obvious to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A plant propagation and display panel comprising:
a plant growth substrate housing;
a back plate coupled to said plant growth substrate housing, said back plate and said plant growth substrate housing providing an opening for receiving a plant growth substrate; and
a plant tray coupled to said plant growth substrate housing, said plant tray comprising a container for receiving a plant plug, said container being at least partly received in said opening.

2. The plant propagation and display panel of claim 1, wherein the assembled display panel is free standing.

3. The plant propagation and display panel of claim 1, comprising a mounting device for coupling said plant propagation and display panel to a support structure.

4. The plant propagation and display panel of claim 1, comprising a plant growth substrate communicably interposed between the plant tray and the plant growth substrate housing.

5. The plant propagation and display panel of claim 1, wherein the back plate is provided with at least one opening therethrough.

6. The plant propagation and display panel of claim 1, wherein at least one side wall of said plant growth substrate housing include an opening therethrough.

7. The plant propagation and display panel of claim 1, comprising at least one rib provided in said plant growth substrate housing, said at least on rib for removably engaging an inner surface said plant growth substrate housing.

8. The plant propagation and display panel of claim 1, wherein a face plate of said plant tray includes at least one aperture extending therethrough.

9. The plant propagation and display panel of claim 1, wherein said container of said plant tray includes at least one opening therethrough.

10. The plant propagation and display panel of claim 1, wherein said back plate is releasably coupled to said plant growth substrate housing.

11. The plant propagation and display panel of claim 1, wherein said plant tray is releasably coupled to said plant growth substrate housing.

12. The plant propagation and display panel of claim 1, comprising an irrigation line in communication with an irrigation system for providing at least water or nutrient-enriched water to the panel.

13. The plant propagation and display panel of claim 1, wherein the plant growth substrate comprises growth additives for the provision of optimized growing conditions for the plant plugs.

14. The plant propagation and display panel of claim 1, comprising at least one sensor for detecting at least one parameter in the plant growth environment.

15. The plant propagation and display panel of claim 14, wherein said at least one sensor is selected from the group consisting of moisture sensors, temperature sensors, pH sensors, nutrient sensors and combinations thereof.

16. The plant propagation and display panel of claim 14, wherein said at least one sensor is wirelessly linked to an external data logger.

17. The plant propagation and display panel of claim 1, comprising a plant plug cover coupled to said plant tray.

18. The plant propagation and display panel of claim 1, further comprising a utility control system for the provision of at least one utility to the panel.

19. The plant propagation and display panel of claim 18, wherein the at least one utility is selected from the group consisting of a heating line, electrical wire, a misting water supply line and combinations thereof.

20. The display panel of claim 1, wherein said plant tray is shaped for nestable stacking with a plurality of plant trays.

21. The display panel of claim 1, wherein said plant growth substrate housing is shaped for nestable stacking with a plurality of plant growth substrate housings.
